(19) United States
(12) Patent Application Publication
(10) Pub. No.: US 2025/0302246 A1
(43) Pub. Date: Oct. 2, 2025

(54) Toilet Brush Drying System

(71) Applicant: Victoria Williams, Atlanta, GA (US)

(72) Inventor: Victoria Williams, Atlanta, GA (US)

(21) Appl. No.: 19/092,525

(22) Filed: Mar. 27, 2025

Related U.S. Application Data
(60) Provisional application No. 63/570,518, filed on Mar. 27, 2024.

(51) Int. Cl. A47K 11/10; A46B 17/06; F16M 13/02

(52) U.S. Cl. CPC A47K 11/10; A46B 17/06; F16M 13/022; A46B 2200/304

(57) ABSTRACT

A toilet brush drying system for cleaning the bowl of a toilet, including a toilet cleaning brush with an elongated handle, a grip portion disposed thereon, and a scrubbing portion disposed thereon. A drying clip includes a body portion and an attachment portion extending downwardly from the body portion, and the toilet cleaning brush is removably secured to the body portion of the drying clip. The attachment portion of the drying clip is configured to be removably secured to the upper edge of the bowl of the toilet as the brush air dries.

### CROSS-REFERENCE TO RELATED APPLICATION

The application claims priority to and the benefit of the filing date of U.S. Provisional Patent Application No. 63/570,518, filed Mar. 27, 2024, the entirety of which is hereby incorporated by reference herein.

### FIELD

The application is generally related to cleaning utensils and, more particularly, to devices and methods of use thereof to facilitate cleaning of toilets with a brush wherein drying of the brush is facilitated.

### BACKGROUND

Brush assemblies for cleaning the inner bowl of toilets are well known. A typical toilet cleaning brush may consist of an elongated handle with a grip disposed at a first end and a brush or scouring pad disposed on the opposite second end. After cleaning the inside of the toilet bowl, the toilet brush or pad retains water that takes varying amounts of time to dry dependent upon factors such as construction of the brush, humidity, etc. As such, it is fairly common to provide a toilet brush holder in which the toilet brush is stored until time for the next use. Known holders include a base portion in which the dirty water retained in the brush is collected as the brush dries. Such holders are prone to retain the standing water therein for prolonged periods of time over which mold may grow in the water. This dirty, moldy water is not only unsightly but may also provide hygiene issues.

From the foregoing, one recognizes the need for devices and systems to facilitate the drying of a previously used toilet brush in a sanitary and orderly fashion.

### SUMMARY

The present disclosure is related to a toilet brush drying system for cleaning the bowl of a toilet. Various embodiments of the system may include a toilet cleaning brush having an elongated handle, a grip portion disposed on a first end of the elongated handle, and a scrubbing portion disposed on a second end of the handle. A drying clip is provided and includes a body portion and an attachment portion extending downwardly from a bottom of the body portion. The toilet cleaning brush is removably secured to a top of the body portion of the drying clip, and the attachment portion of the drying clip is configured to be removably secured to the upper edge of the bowl of the toilet so that the brush portion is suspended above the inside of the bowl of the toilet so that water dripping from the toilet brush is collected in the toilet bowl as the brush portion air dries.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIGS. 1A, 1B, and 1C are perspective views of an embodiment of a toilet brush drying system in accordance with an embodiment of the present disclosure;

FIGS. 2A, 2B, and 2C are various views of the toilet cleaning brush and the drying clip of the toilet brush drying system shown in FIG. 1;

FIGS. 3A, 3B, 3C, and 3D are various views of the drying clip of the toilet brush drying system shown in FIG. 1;

FIGS. 4A and 4B are perspective views of the toilet brush drying system shown in FIG. 1 in use with a corresponding toilet; and

FIG. 5 is a side view of the toilet cleaning brush and drying clip shown in FIG. 4B taken along line 5-5.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used throughout, the singular forms “a,” “an,” and “the” include plural referents unless the context clearly dictates otherwise. Thus, for example, unless the context dictates otherwise, reference to “a clip portion” provides disclosure of embodiments in which only a single such clip portion is provided, as well as embodiments in which a plurality of such clip portions are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedents “about,” “substantially,” or “generally,” it is contemplated that values within up to 15%, up to 10%, up to 5%, or up to 1% (above or below) of the particularly stated value can be included within the scope of those aspects. In other aspects, when angular values are approximated by use of the antecedents “about,” “substantially,” or “generally,” it is contemplated that angular values within up to 15 degrees, up to 10 degrees, up to 5 degrees, or up to one degree (above or below) of the particularly stated angular value can be included within the scope of those aspects.

In the following description and claims, wherever the word “comprise” or “include” is used, it is understood that the words “comprise” and “include” can optionally be replaced with the words “consists essentially of” or “consists of” to form another embodiment.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

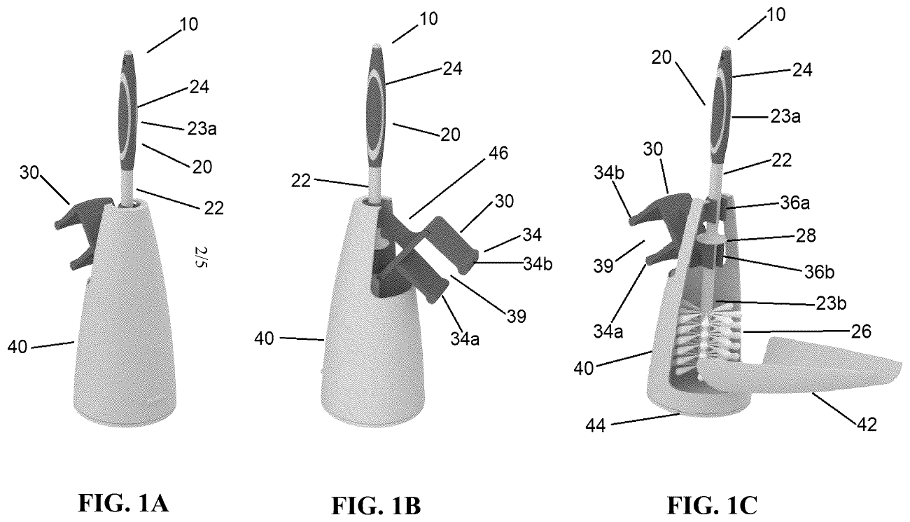

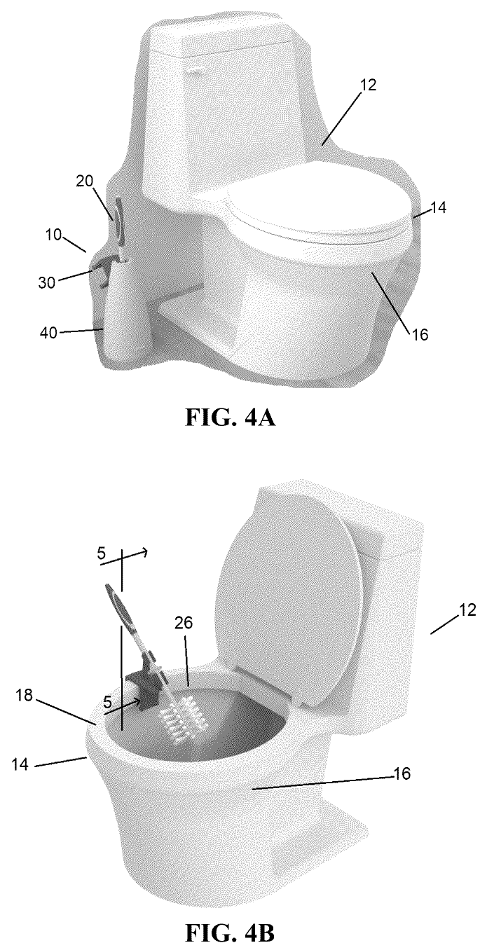

Referring now to the Figures, a toilet brush drying system 10 in accordance with an embodiment of the present disclosure is shown in FIGS. 1A, 1B, and 1C. The toilet brush drying system 10 is configured to allow a toilet cleaning brush 20 to be stored in a hygienic manner within a corresponding brush housing 40 between uses of cleaning a toilet 12 (FIG. 4A). The toilet brush drying system 10 includes a drying clip 30 that allows the toilet cleaning brush 20 to be removably secured to an upper portion of the toilet's bowl 14 such that the brush portion 26 of the toilet cleaning brush 20 is suspended over the interior of the bowl 14. As such, embodiments of the disclosed toilet brush drying system 10 facilitate the drying of the toilet cleaning brush 20 after use as any water retained in the brush portion 26 is allowed to drip into the interior of the toilet bowl 14 as the brush portion 26 air dries.

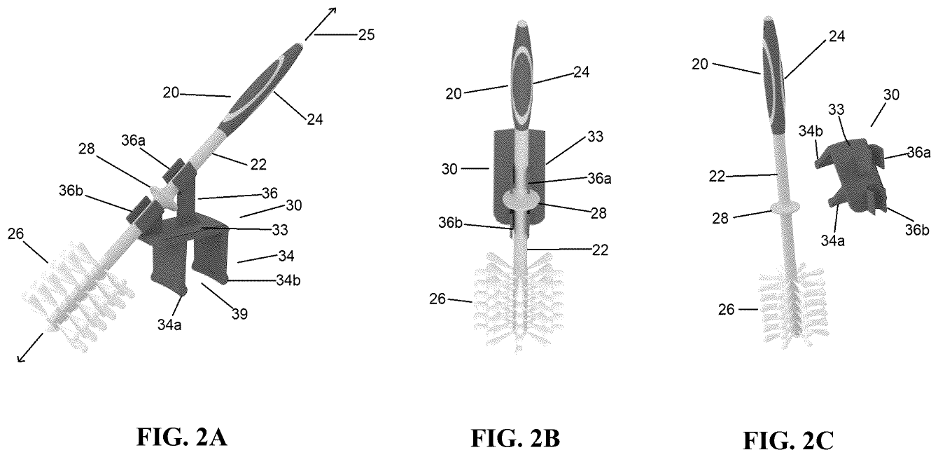

Referring additionally to FIGS. 2A, 2B, and 2C, the toilet cleaning brush 20 of the disclosed embodiment can include an elongated handle 22, including a grip portion 24 disposed at a first end 23a and a brush portion 26 disposed on an opposite second end 23b. The brush portion 26 can be formed of a standard bristle-type brush, a scouring pad, a plurality of radially-extending scrubbing projections, etc. In some aspects, the toilet cleaning brush 20 can include a radially-extending enlarged portion 28 disposed between the grip portion 24 and the brush portion 26 on the elongated handle 22.

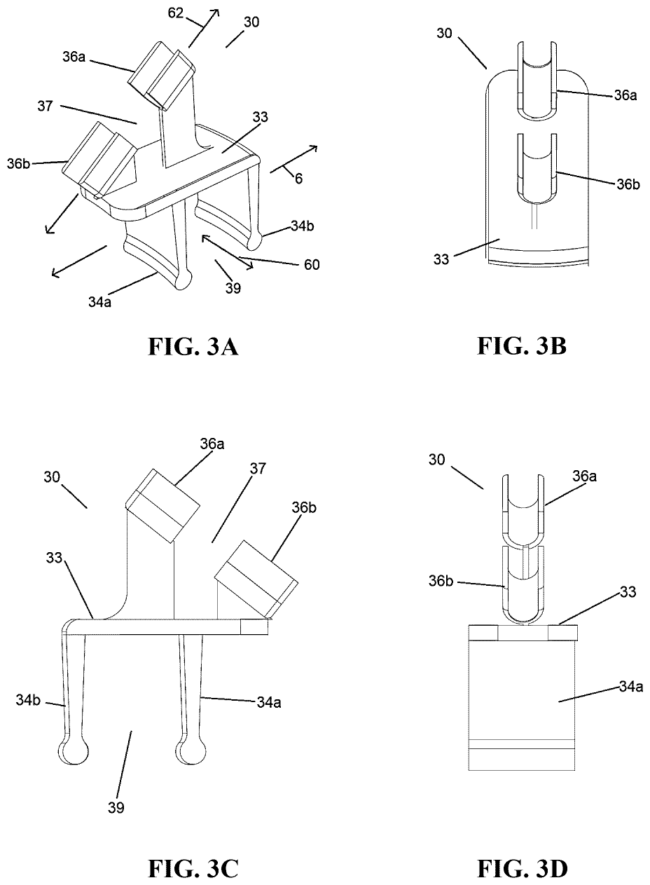

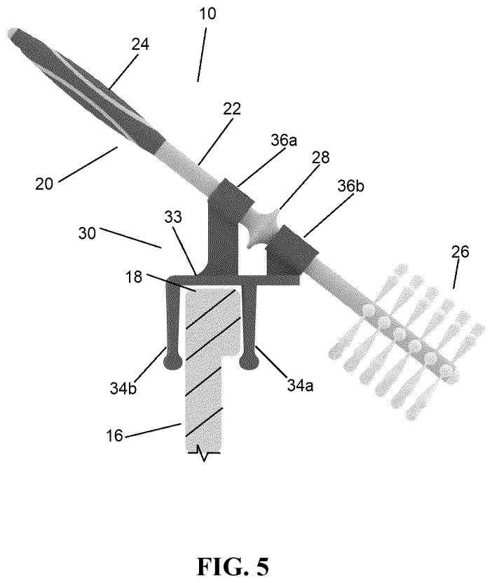

As shown in FIGS. 3A through 3D, an embodiment of a drying clip 30 in accordance with the present disclosure may include a body portion 33 (e.g., optionally, substantially planar body plate), an attachment portion 34 extending downwardly from a bottom surface thereof, and a clip portion 36 extending upwardly from a top surface thereof. In some aspects, and as shown, the attachment portion 34 can include a first leg 34a and a second leg 34b that form a gap 39 therebetween. The length and parallel spacing of the first and second legs 34a and 34b of the attachment portion 34 can be selected so that the drying clip 30 maybe securely, and removably, positioned on the top edge 18 of a sidewall 16 of the toilet bowl 14, as shown in FIGS. 4B and FIG. 5. In some aspects, the first and second legs 34a and 34b can be configured to deflect outwardly from each other to receive the upper portion of the toilet bowl 14. For example, end portions of the first and second legs can widen or project inwardly to define a narrowed portion of the gap 39 therebetween. In this way, the narrowed portion of the gap 39 can snap over the upper portion of the toilet bowl 14 to retain the drying clip 30 thereto.

The clip portion 36 can include at least one clip that extends upwardly from a top surface of the body portion 33. For example, in some optional aspects, the clip portion can comprise a first clip 36a and a second clip 36b that extend upwardly from a top surface of the body plate 33 so that a gap 37 is formed there between, as best seen in FIGS. 3A and 3C. Each of the first and second clips 36a and 36b can be configured to receive a portion of the elongated handle 22 of the toilet cleaning brush 20 in a snap-fit. For example, portions of each of the first and second clips 36a and 36b can resiliently deflect from each other to receive the elongated handle 22.

Referring additionally to FIGS. 2A and 2B, when the elongated handle 22 is removably secured in the clip portion 36, the enlarged portion 28 of the toilet cleaning brush 20 can be received in the gap 37 defined between the first and second clips 36a and 36b to prevent the toilet cleaning brush 20 from sliding within the clip portion 36. Additionally, the enlarged portion 28 of the toilet cleaning brush 20 can be configured to prevent soiled water retained by the brush portion 26 after use from running down the elongated handle 22 and into contact with the user's hand on the grip portion 24, should the brush portion 26 be raised above the grip portion 24 during use. As best seen in FIGS. 2A and 3C, the first clip 36a, or the outermost clip with respect to the bowl 14 of the toilet 12, can be disposed at a greater height above the body plate 33 of the drying clip 30 than the first clip 36b. As such, as best seen in FIG. 5, the drying clip 30 can hold the brush portion 26 below the grip portion 24 to expedite water running down the length of the elongated handle 22, thereby speeding up the drying process of the toilet cleaning brush 20. Note, in alternate embodiments, only one clip may be used as the clip portion, and the enlarged portion 28 of the toilet cleaning brush 20 may be omitted as well. In yet other alternate embodiments, the angle at which a longitudinal center axis 25 of the toilet cleaning brush 20 is oriented during drying may be varied anywhere between vertical and horizontal. For example, the gap 39 between the first and second legs 34a and 34b can form a channel having a first axis 60. In some aspects, the axis can be parallel to the bottom surface of the body portion 33. The clip portion 30 (e.g., the first and second clips 36a,b) can be configured to grip the elongated handle 22 along a second axis 62. In some aspects, the second axis 62 can form an acute angle with a third axis 64 that is perpendicular to the first axis 60.

As shown in FIG. 4A, between uses, the toilet cleaning brush 20 and corresponding drying clip 30 may be stored within a brush housing 40 that is preferably positioned by a corresponding toilet 12. As shown in FIG. 1C, the brush housing 40 can include a pivotal access panel 42 that facilitates insertion and removal of the toilet cleaning brush 20. As well, the brush housing 40 can include a solid bottom floor 44 to retain any water that may drip from the toilet cleaning brush 20 when stored therein. The brush housing 40 can be configured to receive the toilet cleaning brush 20 with the drying clip 30 attached thereto. For example, the brush housing 40 can define a cutout 46 that is configured to receive the drying clip 30.

After cleaning with the toilet cleaning brush 20, as shown in FIG. 4B, a user can position an assembly comprising the toilet cleaning brush and attached drying clip 30 so that a portion of the sidewall 16 of the toilet bowl 14 is between the first and second legs 34a and 34b of the attachment portion 34, and so that the brush portion 26 of the toilet cleaning brush 20 is suspended within the interior of the toilet's bowl 14. As previously noted, the angled orientation with which the drying clip 30 holds the toilet cleaning brush 20 with respect to the toilet 12 can facilitate the rapid air drying of the brush portion 26 of the toilet cleaning brush 20. Upon drying, the toilet cleaning brush 20 can be returned to the brush housing 40. Preferably, the toilet cleaning brush 20 can be suspended from an upper portion of the brush housing 40 so that the brush portion 26 is not in contact with the inner surface of the bottom floor 44 of the housing 40. Note, in alternate embodiments, the drying clip 30 and the toilet cleaning brush 20 may be unitarily formed rather than being formed as two separate pieces that are selectively secured together.

Although the foregoing invention has been described in some detail by way of illustration and example for purposes of clarity of understanding, certain changes and modifications may be practiced within the scope of the appended claims.

What is claimed is:

1. A toilet brush drying system for cleaning a toilet having a bowl with an upper edge, comprising:
a toilet cleaning brush comprising:
an elongated handle;
a grip portion disposed on a first end of the elongated handle;
a scrubbing portion disposed on a second end of the handle; and
a drying clip comprising:
a body portion; and
an attachment portion extending downwardly from a bottom of the body portion;
wherein the toilet cleaning brush is secured to, or is configured to be secured to, the drying clip, and
wherein the attachment portion of the drying clip is configured to be removably secured to an upper edge of the bowl of the toilet.

2. The toilet brush drying system of claim 1, wherein the toilet cleaning brush is removably secured to the drying clip.

3. The toilet brush drying system of claim 2, wherein the drying clip further comprises a clip portion extending upwardly from the body portion, the clip portion being configured to releasably engage the elongated handle of the toilet cleaning brush.

4. The toilet brush drying system of claim 3, where in the clip portion further comprises a first clip and a second clip separated by a gap therebetween, wherein the elongated handle comprises a radially extending portion, wherein the gap is configured to receive the radially extending portion of the elongated handle of the toilet cleaning brush therein.

5. The toilet brush drying system of claim 4, wherein the drying clip is configured to attach to the toilet bowl so that a longitudinal center axis of the toilet cleaning brush forms an acute angle with respect to a vertical axis of the toilet bowl so that the scrubbing portion of the toilet cleaning brush is disposed below the handle portion when the toilet cleaning brush and drying clip are secured to the bowl of the toilet.

6. The toilet brush system of claim 5, wherein the first clip has a first vertical spacing from the body portion, wherein the second clip has a second spacing from the body portion that is different from the first spacing.

7. The toilet brush drying system of claim 1, wherein the drying clip is configured to attach to the toilet bowl so that a longitudinal center axis of the toilet cleaning brush forms an acute angle with respect to a vertical axis of the toilet bowl so that the scrubbing portion of the toilet cleaning brush is disposed below the handle portion when the toilet cleaning brush and drying clip are secured to the bowl of the toilet.

8. The toilet brush drying system of claim 2, further comprising a storage housing including a body portion configured to receive the scrubbing portion of the toilet cleaning brush therein when the toilet cleaning brush is not in use.

9. The toilet brush drying system of claim 8, wherein the drying clip is configured to releasably engage an upper portion of the storage housing so that the toilet cleaning brush is retained within the storage housing in a vertical orientation.

10. The toilet brush drying system of claim 8, wherein the storage housing further comprises an access panel that is pivotably movable between an open position and a closed position to facilitate placing the scrubbing end of the toilet cleaning brush therein.

11. The toilet brush drying system of claim 8, wherein the storage housing define a cutout that is configured to receive the drying clip therethrough.

12. The toilet brush drying system of claim 1, wherein the scrubbing portion of the toilet cleaning brush is one of a bristle brush and a scouring pad.

13. The toilet drying system of claim 1, wherein the attachment portion comprises a pair of downwardly depending legs that are configured to slidably receive a portion of the upper edge of the bowl therebetween.

14. The toilet drying system of claim 13, wherein the pair of downwardly depending legs define a gap that narrows distally from the body portion, wherein the pair of downardly depending legs are configured to deflect outwardly from each other to receive the upper edge of the bowl of the toilet.

15. The toilet brush drying system of claim 1, wherein the toilet cleaning brush is integrally formed with the drying clip.

16. A drying clip that is configured to attach to a toilet cleaning brush including an elongated handle, a grip portion disposed on a first end of the elongated handle, and a scrubbing portion disposed on a second end of the handle, the drying clip comprising:
a body portion;
an attachment portion extending downwardly from a bottom of the body portion, wherein the attachment portion is configured to be removably secured to an upper edge of the bowl of the toilet; and
a clip portion extending upwardly from the body portion, the clip portion being configured to releasably engage the elongated handle of the toilet cleaning brush.

17. The toilet brush drying system of claim 16, where in the clip portion further comprises a first clip and a second clip separated by a gap therebetween, wherein the first clip has a first vertical spacing from the body portion, wherein the second clip has a second spacing from the body portion that is different from the first spacing.
